(19) United States
(12) Patent Application Publication
(10) Pub. No.: US 2026/0118845 A1
(43) Pub. Date: Apr. 30, 2026

(54) PROGRAMMABLE CONTROLLER, TERMINAL DEVICE, METHOD OF PROVIDING INFORMATION, AND RECORDING MEDIUM

(71) Applicant: Mitsubishi Electric Corporation, Tokyo (JP)

(72) Inventor: Koki KOMABA, Tokyo (JP)

(73) Assignee: Mitsubishi Electric Corporation, Tokyo (JP)

(21) Appl. No.: 19/163,415

(22) PCT Filed: Dec. 11, 2023
(86) PCT No.: PCT/JP2023/044180

§ 371 Date: Sep. 9, 2025

(51) Int. Cl. G05B 19/05

(52) U.S. Cl. CPC G05B 19/05; G05B 2219/14055

(57) ABSTRACT

A programmable logic controller (PLC) includes a program executor that executes a control program, a value log collector that collects logs of device values stored in a memory during execution of the control program, an event log collector that collects logs of predetermined events occurring inside the PLC and including operation events on the device values, a communication log collector that collects logs of communication data transmitted or received by a communicator responsible for communication via a network, a time information acquirer that acquires time information indicating time, and a provider that provides the logs of the device values, the logs of the predetermined events, and the logs of the communication data in association with the time information indicating times of collection of the individual logs.

### TECHNICAL FIELD

The present disclosure relates to a programmable controller, a terminal device, a method of providing information, and a program.

### BACKGROUND ART

Many factory automation (FA) systems are operated because a programmable logic controller (PLC) executes a user program generated by a user and thus controls various machines. Accompanying the development of information communication technology in recent years, such as Internet of things (IoT) techniques and cloud systems, the PLC is often connected to and communicates with external apparatuses. These external apparatuses may cause an unexpected operation of the user program during control of the machines by the PLC.

The cause of such an unexpected operation of the user program can be smoothly identified by techniques of recording logs (for example, refer to Patent Literature 1). Patent Literature 1 discloses a technique for facilitating error analysis through recording of log data on communications of the PLC and log data on statuses containing errors of the PLC.

### CITATION LIST

### Patent Literature

Patent Literature 1: Unexamined Japanese Patent Application Publication No. 2019-197461

### SUMMARY OF INVENTION

### Technical Problem

The technique disclosed in Patent Literature 1, however, sometimes requires significant time to identify the cause of an error. For example, an error may occur in the PLC due to a failure in writing of data on control details, regardless of transmission of the command to write the data to the PLC via communication. In such a case, an operator cannot readily identify the failure in writing as the cause of the error, even if the operator notices the error on the basis of the log data on statuses and finds out the command to write the data on the basis of the log data on communications. This situation may lead to extended time required for a maintenance operation based on the logs recorded in the PLC.

An objective of the present disclosure, which has been accomplished under the above situations, is to reduce the time required for a maintenance operation based on the logs recorded in the PLC.

### Solution to Problem

In order to achieve the above objective, a data management apparatus according to the present disclosure is a programmable controller for controlling a machine, and includes: program execution means for executing a control program for controlling the machine; a memory to be shared with the machine; value log collection means for collecting logs of values stored in the memory during execution of the control program; event log collection means for collecting logs of predetermined events occurring inside the programmable controller and including operation events on the values stored in the memory; communication means for communicating with at least one of the machine and a device different from the machine via a network; communication log collection means for collecting logs of communication data transmitted or received by the communication means; time information acquisition means for acquiring time information indicating time; and provision means for providing the logs of the values, the logs of the predetermined events, and the logs of the communication data in association with the time information indicating times of collection of the individual logs.

### Advantageous Effects of Invention

The present disclosure can reduce the time required for a maintenance operation based on the logs recorded in the PLC.

### BRIEF DESCRIPTION OF DRAWINGS

FIG. 1 illustrates a configuration of an information service system according to Embodiment 1;

FIG. 2 illustrates hardware components of an FA device according to Embodiment 1;

FIG. 3 illustrates a functional configuration of a PLC and a terminal device according to Embodiment 1;

FIG. 4 illustrates an exemplary list of value logs according to Embodiment 1;

FIG. 5 illustrates an exemplary list of event logs according to Embodiment 1;

FIG. 6 illustrates a structure of request data according to Embodiment 1;

FIG. 7 is a first diagram illustrating a structure of response data according to Embodiment 1;

FIG. 8 is a second diagram illustrating a structure of the response data according to Embodiment 1;

FIG. 9 illustrates an exemplary list of communication data logs according to Embodiment 1;

FIG. 10 illustrates exemplary information on error codes according to Embodiment 1;

FIG. 11 illustrates an exemplary screen displayed on a display according to Embodiment 1;

FIG. 12 illustrates a list of communication data logs displayed on the display according to Embodiment 1;

FIG. 13 illustrates an example in which a user selects a log from a list of communication data logs according to Embodiment 1;

FIG. 14 illustrates an exemplary manner of displaying a process of coping with an error according to Embodiment 1;

FIG. 15 illustrates a first exemplary screen for emphasizing a correspondence between logs on the display according to Embodiment 1;

FIG. 16 illustrates a second exemplary screen for emphasizing a correspondence between logs on the display according to Embodiment 1;

FIG. 17 illustrates a process of providing information according to Embodiment 1; and

FIG. 18 illustrates a correspondence between logs according to Embodiment 2.

### DESCRIPTION OF EMBODIMENTS

The following describes an information service system according to the embodiment, with reference to the accompanying drawings.

### Embodiment 1

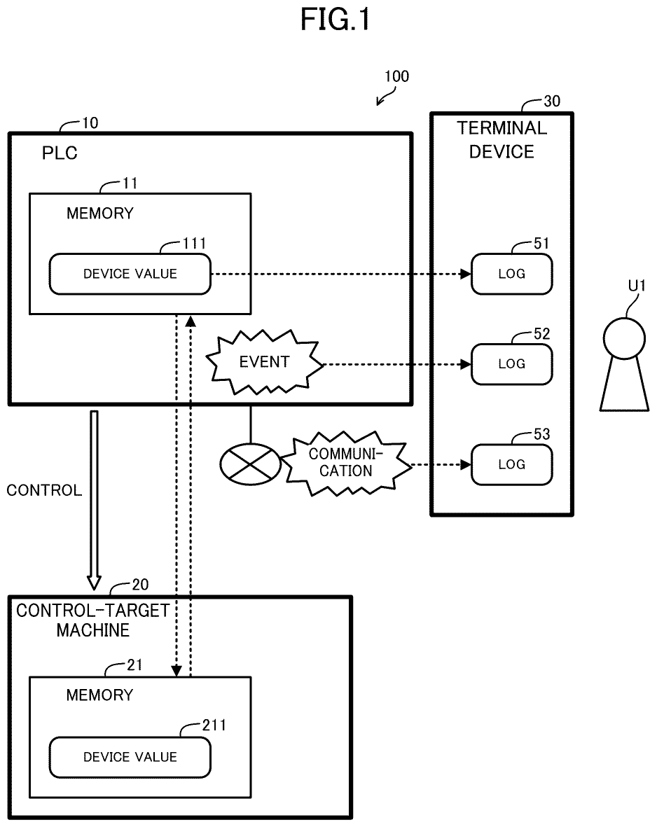

An information service system 100 according to this embodiment corresponds to a part of a production system, a machining system, an inspection system, or another processing system established in a factory or a plant. As illustrated in FIG. 1, the information service system 100 provides a user U1 with logs recorded in a programmable logic controller (PLC) 10 via a user interface (UI) of a terminal device 30, and thus helps the user U1 check for detailed functions of the PLC 10. This checking operation is typically a maintenance operation for identifying the cause of an error. The checking operation may also be a part of operations of managing the quality of subjects to be processed through the control of the PLC 10, operations of managing processes for improving the efficiency of the control of the PLC 10, or other operations.

The PLC 10 is connected to a control-target machine 20 via a network, such as field network, or a dedicated line, and controls the control-target machine 20. The PLC 10 corresponds to an example of a programmable controller for controlling a machine. The PLC 10 executes various processes by controlling the control-target machine 20. For example, the control of the PLC 10 operates a production line for processing workpieces and manufacturing products, an inspection line for inspecting workpieces, or a machine processing line for processing workpieces.

The PLC 10 includes a memory 11 that stores a device value 111, whereas the control-target machine 20 includes a memory 21 that stores a device value 211. The device values stored in the memories 11 and 21 are made identical, typically by so-called cyclic transmission. In other words, the memory 11 is shared between the PLC 10 and the control-target machine 20.

Although FIG. 1 illustrates a single control-target machine 20 as a representative, the control-target machine 20 may be replaced with two or more control-target machines 20. Each of the control-target machines 20 shares the memory 11 of the PLC 10 with the PLC 10. The sharing of the memory 11 allows the PLC 10 to execute various control processes. For example, the device value 211 indicating a result of sensing by the control-target machine 20 serving as a sensor is written into the memory 21, and is then synchronized with the device value 111 in the memory 11, so that the sensing result is provided to the PLC 10. On the basis of this sensing result, the PLC 10 stores, into the memory 11, the device value 111 indicating an operation instruction to the control-target machine 20 serving as a robot. The device value 111 is then synchronized with the device value 211 of the robot, so that the robot operates in accordance with the operation instruction. The control-target machine 20 corresponds to an example of a machine to be controlled by the programmable controller.

That is, the device value 111 in the PLC 10 is used to execute various control processes for the control-target machine 20. The details of the control processes can thus be analyzed subsequently on the basis of a history of the device values 111 recorded in the form of logs 51. The logs 51 reveal a transition of the device values 111, but do not necessarily help the user U1 identify the cause of a change in the device values 111. The PLC 10 thus detects and records events that possibly change the device values 111, and provides the user U1 with the events in the form of logs 52. The logs 52 reveal a transition of the events occurring inside the PLC 10, but do not necessarily help the user U1 recognize events occurring outside the PLC 10. The PLC 10 thus provides the user U1 with a history of communications in the form of logs 53.

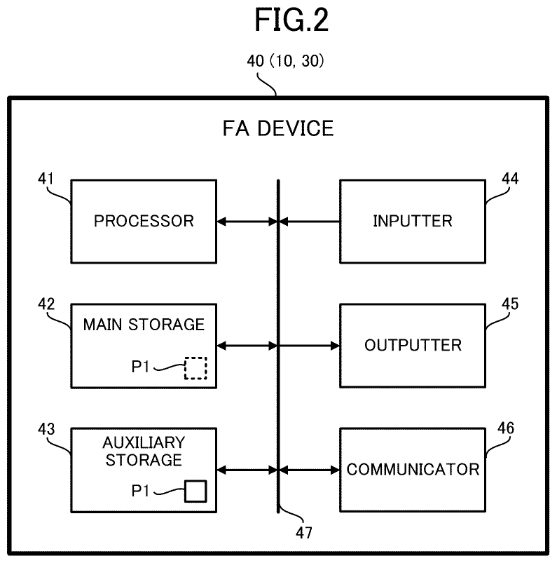

Each of the PLC 10 and the terminal device 30 includes hardware components to function as a computer. In detail, as illustrated in FIG. 2, an FA device 40 corresponding to each of the PLC 10 and the terminal device 30 includes a processor 41, a main storage 42, an auxiliary storage 43, an inputter 44, an outputter 45, and a communicator 46. The main storage 42, the auxiliary storage 43, the inputter 44, the outputter 45, and the communicator 46 are each connected to the processor 41 via internal buses 47.

The processor 41 includes a central processing unit (CPU) or a micro processing unit (MPU) serving as a processing circuit. The processor 41 executes a program P1 stored in the auxiliary storage 43 and thereby performs various functions to execute the process described below. The program P1 in the PLC 10 corresponds to an example of a control program for controlling the control-target machine 20.

The main storage 42 includes a random access memory (RAM). The main storage 42 receives the program P1 loaded from the auxiliary storage 43. The main storage 42 serves as a work area of the processor 41.

The auxiliary storage 43 includes a non-volatile memory, such as electrically erasable programmable read-only memory (EEPROM) or hard disk drive (HDD). The auxiliary storage 43 stores the program P1 and various types of data to be used in the processes of the processor 41. The auxiliary storage 43 provides the processor 41 with data to be used by the processor 41, under the instructions from the processor 41. The auxiliary storage 43 stores data fed from the processor 41.

The inputter 44 includes an input device, such as hardware switch, input key, keyboard, or pointing device. The inputter 44 acquires information input by a user of the FA device 40, and notifies the processor 41 of the acquired information.

The outputter 45 includes an output device, such as light emitting diode (LED), liquid crystal display (LCD), or speaker. The outputter 45 presents various types of information to the user of the FA device 40, under the instruction from the processor 41.

The communicator 46 includes a communication interface circuit for communication with external apparatuses. The communicator 46 receives signals from the external apparatuses, and outputs data indicated by these signals to the processor 41. The communicator 46 also transmits, to the external apparatuses, signals indicating data output from the processor 41. Although FIG. 2 illustrates a single communicator 46 as a representative, the FA device 40 may include multiple communicators 46. For example, the PLC 10 may include a communicator 46 for communication with the control-target machine 20 and another communicator 46 for communication with the terminal device 30, separately. The communicator 46 of the PLC 10 may communicate with both of the control-target machine 20 and the terminal device 30 via the above-mentioned network, or may communicate with the control-target machine 20 via the network and communicate with the terminal device 30 via a universal serial bus (USB) cable, for example.

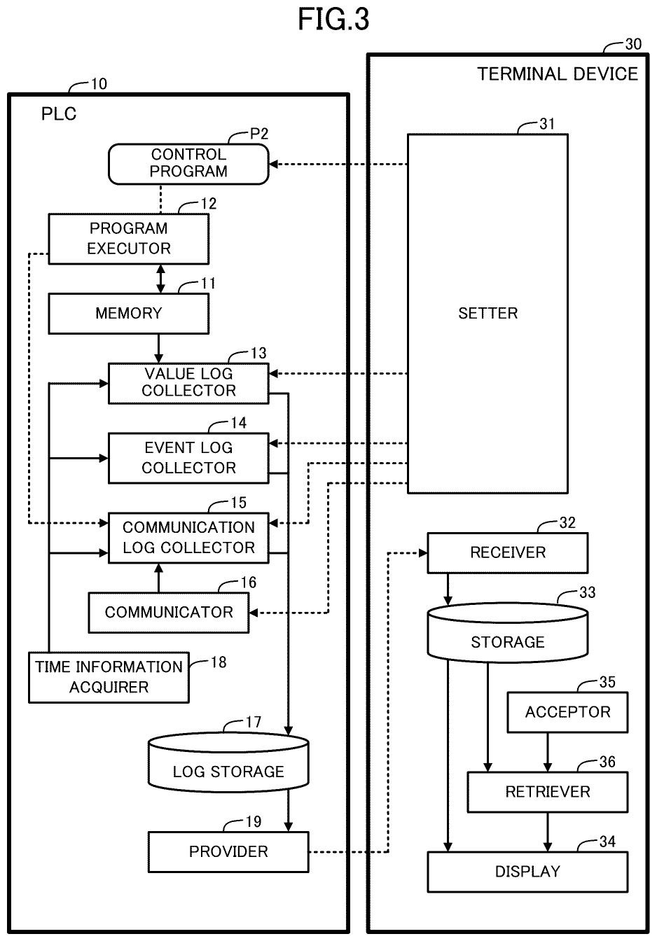

Cooperation of the above-described hardware components allows the PLC 10 and the terminal device 30 to perform various functions. In detail, as illustrated in FIG. 3, the PLC 10 has functional components including the memory 11 that stores device values, a program executor 12 that executes a control program P2 for controlling the control-target machine 20, a value log collector 13 that collects device value logs of device values at regular intervals, an event log collector 14 that detects events occurring inside the PLC 10 and thus collects event logs of the predetermined events, a communication log collector 15 that collects communication logs of communications performed by a communicator 16, the communicator 16 that communicates with external apparatuses, a log storage 17 that accumulates and stores the logs collected by the value log collector 13, the event log collector 14, and the communication log collector 15, a time information acquirer 18 that acquires time information indicating time, and a provider 19 that provides the logs stored in the log storage 17 to the terminal device 30.

The memory 11 is mainly implemented by the main storage 42. The program executor 12 is mainly implemented by the processor 41 of the PLC 10. The program executor 12 executes the control program P2 written into the PLC 10 by the terminal device 30. The control program P2 corresponds to the program P1 in the PLC 10, and is developed using the ladder diagram language or C language, for example.

The execution of the control program P2 by the program executor 12 initiates reading and writing of the device values from and into the memory 11, thereby controlling the control-target machine 20.

The program executor 12 corresponds to an example of program execution means for executing a control program for controlling the machine.

The value log collector 13 is mainly implemented by the processor 41 of the PLC 10. The value log collector 13 collects target device values defined by a setter 31 of the terminal device 30, in accordance with collection parameters defined by the setter 31. The target device values may be all the device values used in the control program P2, values selected by the user U1 from the device values used in the control program P2, or values arbitrarily defined regardless of whether the values are used in the control program P2.

The collection parameters include a cycle and a period of collection of device values. The cycle is 100 microseconds, 100 milliseconds, 1 second, or 1 minute, for example. The period starts at a timing of activation of the PLC 10, reset of the power supply, reception of an instruction to start the collection from the terminal device 30, occurrence of a designated initiation trigger, or satisfaction of designated initiation conditions, for example. The period ends at a timing of a certain termination manipulation on the PLC 10, reception of an instruction to terminate the collection from the terminal device 30, elapse of a certain time defined as one of the collection parameters, occurrence of a designated termination trigger, or satisfaction of designated termination conditions, for example.

With every reading of device values, the value log collector 13 acquires time information from the time information acquirer 18. Examples of the time information include a timestamp directly indicating time, and a count value, like the value of a scan counter, increasing or decreasing with time. The scan counter measures the number of repetitions of a scanning process, corresponding to execution of a single control process defined in the control program P2, executed by the program executor 12. The scan counter is implemented by the processor 41.

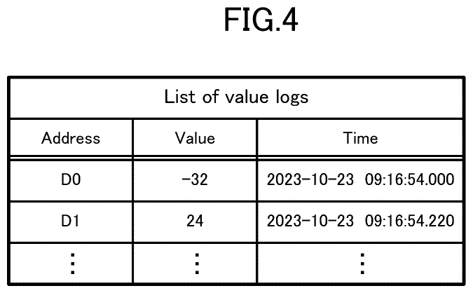

The value log collector 13 writes the device values read from the memory 11 into the log storage 17 in the form of a device value log, in association with the time information corresponding to the time of reading. FIG. 4 illustrates exemplary logs accumulated in the log storage 17 by the value log collector 13. As illustrated in FIG. 4, the accumulated logs constitute a log list indicating row data that associates with each other the addresses of device values in the memory 11, the device values, and the times of collection of the device values. This log list shows a transition of the collected device values. The value log collector 13 corresponds to an example of value log collection means for collecting, during execution of the control program, logs of values stored in the memory.

The event log collector 14 is mainly implemented by the processor 41 of the PLC 10. The events detected and collected by the event log collector 14 are identified by predetermined event codes, and include operation events on device values. Examples of the operation events on device values include reading and writing of device values caused by execution of the control program P2, and reading and writing of device values from and into the memory 11 performed by an external apparatus outside the PLC 10 regardless of execution of the control program P2. The external apparatus may be the control-target machine 20 or the terminal device 30, or may be another machine.

The events detected and collected by the event log collector 14 may include, not only the operation events on device values, but also operation events to files stored in a storage separate from the memory 11 of the PLC 10. This storage may be implemented by the auxiliary storage 43 of the PLC 10, or may be a non-transitory removable recording medium, such as memory card. The events detected and collected by the event log collector 14 may include events other than the operation events on device values and files. For example, the events may include activation or deactivation of the PLC 10 and initialization of the memory 11. These events are preferably events possibly affecting the control processes of the PLC 10 or events resulting from the control processes of the PLC 10.

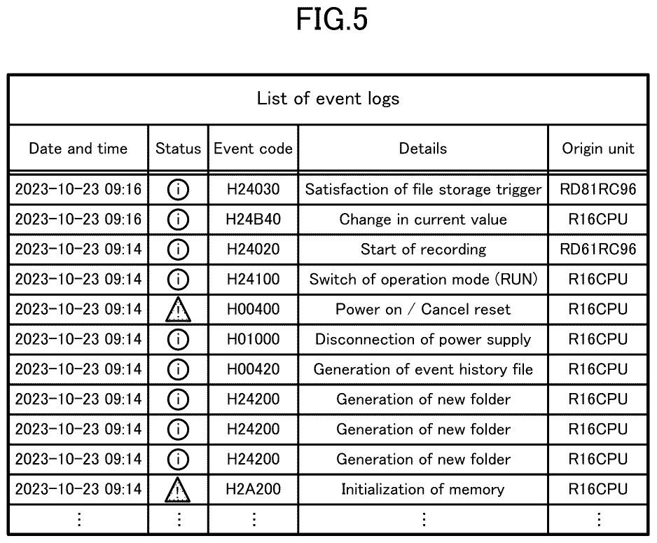

With every detection of an event, the event log collector 14 acquires time information from the time information acquirer 18, and writes information indicating the detected event into the log storage 17 in the form of an event log, in association with the time information. FIG. 5 illustrates exemplary logs accumulated in the log storage 17 by the event log collector 14. As illustrated in FIG. 5, the accumulated logs constitute a log list indicating row data that associates with each other the dates and times of occurrence of the events, the event statuses predetermined depending on the importance levels of the events, the event codes of the events, the details of the events, and the origin units of the events. The origin units each refer to a unit in which the event occurs in the PLC 10 of a building-block type including a combination of units. The event log collector 14 corresponds to an example of event log collection means for collecting logs of predetermined events occurring inside the programmable controller, the predetermined events including operation events on the values stored in the memory.

The communication log collector 15 is mainly implemented by the processor 41 of the PLC 10. The communication log collector 15 collects, from the communicator 16, communication data transmitted to or received from an external apparatus by the communicator 16. The external apparatus that communicates with the communicator 16 may be the control-target machine 20, the terminal device 30, or another device. The communicator 16 may communicate with the external apparatus via a network, such as field network or Internet, as in the example in FIG. 1, or via a dedicated line. The communicator 16 may also perform socket communication with the control-target machine 20. Alternatively, the communication log collector 15 may collect communication data transmitted through multiple communication channels.

If the communication log collector 15 collects all the communication data, the communication log collector 15 has to handle an excessively large volume of data. The communication log collector 15 thus narrows down the collection targets and thus collects only the communication data defined by the setter 31 of the terminal device 30. For example, the communication log collector 15 collects communication data containing an operation command directed to device values used in the control program P2.

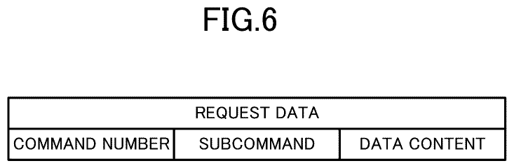

The operation command directed to device values is an instruction to execute reading and writing of the device values. FIG. 6 is a schematic diagram illustrating a structure of request data for requesting the PLC 10 to execute a command, as an example of communication data containing an operation command directed to device values.

As illustrated in FIG. 6, the request data contains a command number, a subcommand, and data content. The command number is preliminarily assigned to each command. The correspondence relationships between the commands and the command numbers are shared between communication partners in advance. The command may be an operation command directed to device values or another command. The subcommand is an auxiliary parameter in addition to the command and may be omitted. The subcommands may be replaced with subcommand numbers preliminarily assigned to the subcommands like the command numbers.

The data content includes information indicating the target of the command. In the case where the command is an operation command, the data content includes information indicating an operation target. For example, the request data for reading the device value at the address “A10” includes a command number “1000” corresponding to reading of a device value and data content “A10” for address designation.

The communication log collector 15 is notified by the program executor 12 of information on the device values to be referenced during execution of the control program P2. The information on the device values contains the addresses of the device values. In an exemplary case where a device value at the address “A10” is used in the control program P2 on the basis of the address “A10” designated in the source code of the control program P2, the collection targets of the communication log collector 15 include request data having data content “A10” for address designation. In contrast, in another exemplary case where the device value at the address “A10” is not used in the control program P2, the collection targets of the communication log collector 15 exclude request data having data content “A10” for address designation.

After any change in the device values used in the control program P2, the communication log collector 15 collects communication data containing an operation command directed to the changed device values, excludes the communication data containing an operation command directed to the device values before the change from the collection targets. For example, when the device values used in the control program P2 is changed from “A10” to “A20”, the communication log collector 15 is notified of this change by the program executor 12, stops the collection of logs of communication data containing an operation command directed to the device value at the address “A10”, and starts the collection of logs of communication data containing an operation command directed to the device value at the address “A20”.

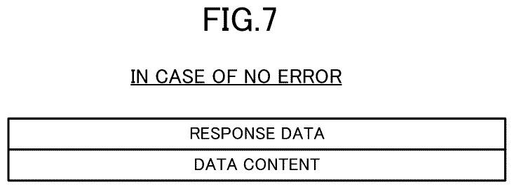

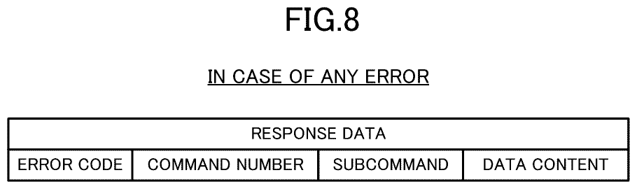

In addition to the request data illustrated in FIG. 6, the communication log collector 15 may also collect response data as a response to the request data. FIGS. 7 and 8 are each a schematic diagram illustrating a structure of the response data. The response data in the case of no error illustrated in FIG. 7 has data content. In the case where the response data is a response to request data for requesting reading of the device values from the PLC 10, the data content indicates the requested device values.

The response data in the case of any error illustrated in FIG. 8 has an error code, a command number, a subcommand, and data content. The error code is provided to identify details of the error. The command number and the subcommand are identical to those contained in the request data. The data content includes information on a target of the command.

Although the collection targets of the communication log collector 15 include communication data regarding the device values used in the control program P2 in the above example, the communication log collector 15 may collect communication data containing an operation command directed to the device values used as parameters of the control program P2. The device values used as parameters of the control program P2 are not written directly in the source code of the control program P2, but affect the details of processing of the processor 41 for executing the control program P2 and are indirectly referenced in accordance with the description of the source code.

Although the collection targets of the communication log collector 15 include communication data regarding the device values in the above examples, the communication log collector 15 may collect communication data regarding files, instead of the device values. In detail, the communication log collector 15 may collect communication data containing an operation command directed to files used in the control program P2, and files used as parameters of the control program P2. These files are stored in a storage separate from the memory 11. The storage may be implemented by the auxiliary storage 43 of the PLC 10, or may be a non-transitory removable recording medium, such as memory card. The communication log collector 15 may be notified by the program executor 12 of information on files to be referenced during execution of the control program P2.

The communication log collector 15 corresponds to an example of communication log collection means for collecting the logs of the communication data containing an operation command directed to the values used in the control program or used as parameters of the control program or directed to files stored in a storage separate from the memory.

Although the collection targets of the communication log collector 15 are narrowed down by designation of certain data, such as device values and files, in the above example, the collection targets may be narrowed down by other procedures. For example, the communication log collector 15 may be notified by the program executor 12 of a protocol regarding the control program P2, and collect communication data transmitted in accordance with this protocol. Examples of the protocol regarding the control program P2 include a protocol used in the control program P2 and a protocol of communications related to the parameters of the control program P2.

The protocol used in the control program P2 sets the standard for communications conducted during execution of the control program P2. Examples of this protocol include file transfer protocol (FTP) and simple network time protocol (SNTP) of communication processing when the source code of the control program P2 defines the communication processing in accordance with this protocol. The protocol of communications related to the parameters of the control program P2 sets the standard for communications conducted during execution of the control program P2, although the source code of the control program P2 does not directly define a command to execute communication processing. Specifically, this communication protocol is applied in communications through which the program executor 12 acquires parameters necessary for determining details of the processing during execution of the control program P2.

After any change in the protocol regarding the control program P2, the communication log collector 15 collects communication data transmitted in accordance with the changed protocol, and excludes communication data transmitted in accordance with the protocol before the change from the collection targets. The communication log collector 15 corresponds to an example of the communication log collection means for collecting the logs of the communication data transmitted in accordance with a protocol used in the control program or a protocol of communications related to parameters of the control program.

The collection of communication data may involve any combination of the procedures of narrowing down the collection targets by designation of certain data and the procedures of narrowing down the collection targets based on a certain protocol. For example, the collection targets may include both of the communication data containing an operation command directed to the device values used in the control program P2, and the communication data transmitted in accordance with the protocol of communications related to the parameters of the control program P2.

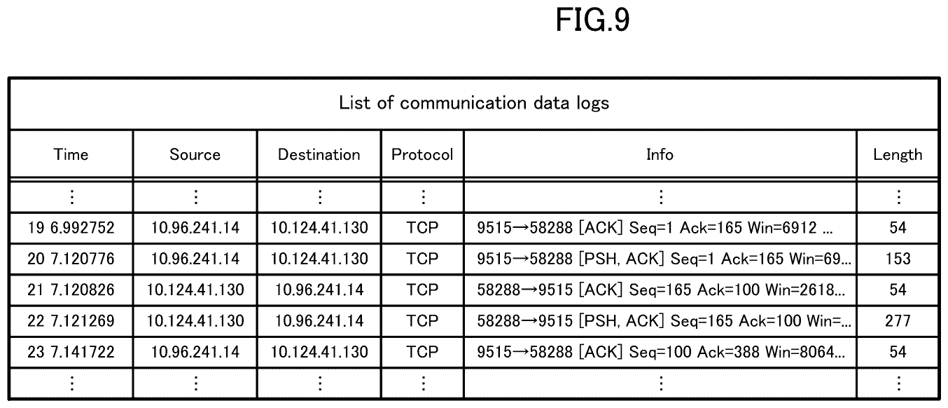

With every acquisition of communication data, the communication log collector 15 acquires time information from the time information acquirer 18, and writes the communication data and the time information in association with each other into the log storage 17 in the form of a communication data log. FIG. 9 illustrates exemplary logs accumulated in the log storage 17 by the communication log collector 15. As illustrated in FIG. 9, the accumulated logs constitute a log list corresponding to row data that associates with each other Time indicating the time of transmission or reception of the communication data, Source indicating the source of the communication data, Destination indicating the destination of the communication data, Protocol indicating the protocol which the communication data is transmitted in accordance with, Info indicating the content of the communication data, and Length indicating the length of the communication data.

When the communication data contains an operation command directed to the device values, the event log collector 14 detects an event of an operation on the device values in accordance with the operation command. That is, both of the communication log collector 15 and the event log collector 14 collect logs, for an operation command from an external apparatus. These logs are mutually different in that the logs collected by the communication log collector 15 are in a format of communication data, whereas the logs collected by the event log collector 14 are in a format provided with an event code. The event logs inside and outside the PLC 10 recorded in different formats enable the user U1 to analyze these events in detail.

The time information is expressed in different formats among the device value logs illustrated in FIG. 4, the event logs illustrated in FIG. 5, and the communication data logs illustrated in FIG. 9. The time information may be in different formats if the time information may be converted into any common one of the formats.

Referring back to FIG. 3, the communicator 16 is mainly implemented by the communicator 46 of the PLC 10. The communicator 16 is provided with communication parameters defined by the setter 31 of the terminal device 30, and communicates with external apparatuses in accordance with the defined communication parameters. The communication parameters contain the internet protocol (IP) address of the PLC 10 itself and the addresses of external apparatuses, for example. The communicator 16 corresponds to an example of communication means for communicating with at least one of the machine or a device different from the machine via a network.

The log storage 17 is mainly implemented by the auxiliary storage 43 of the PLC 10. The time information acquirer 18 is mainly implemented by the processor 41 of the PLC 10. The time information acquirer 18 may acquire time measured inside the PLC 10, or acquire information on time from an external apparatus, such as time server. The time information acquirer 18 corresponds to an example of time information acquisition means for acquiring time information indicating time. The provider 19 is mainly implemented by the processor 41 of the PLC 10. The provider 19 reads the logs from the terminal device 30 in response to a request from the terminal device 30, and provides the read logs to the terminal device 30. The provider 19 corresponds to an example of provision means for providing the logs of the device values, the logs of the predetermined events, and the logs of the communication data in association with the time information indicating times of collection of the individual logs.

Examples of the terminal device 30 include industrial personal computers (PC) and tablets. As illustrated in FIG. 3, the terminal device 30 includes the setter 31 that defines some parameters related to recording of logs in the PLC 10, a receiver 32 that receives various logs from the PLC 10, a storage 33 that stores a large number of received logs, a display 34 that displays lists of logs, an acceptor 35 that accepts designation of any of the logs from the user U1, and a retriever 36 that retrieves other types of logs associated with the designated log. The setter 31, the receiver 32, the storage 33, the display 34, the acceptor 35, and the retriever 36 each correspond to a part of the functions of an engineering tool, which is a software application that allows the user U1 to generate and edit the control program P2 and write the control program P2 into the PLC 10.

The setter 31 is mainly implemented by the processor 41 of the terminal device 30. The setter 31 defines, in the PLC 10, parameters related to collection of device value logs by the value log collector 13, parameters related to collection of event logs by the event log collector 14, parameters related to narrowing down of collection targets by the communication log collector 15, and communication parameters of the communicator 16, in accordance with instructions from the user U1.

The receiver 32 is mainly implemented by the communicator 46 of the terminal device 30. The receiver 32 corresponds to an example of reception means for receiving, in association with time information indicating times of collection of individual logs by the PLC 10, the logs of the device values, the logs of the predetermined events, and the logs of the communication data provided from the PLC 10.

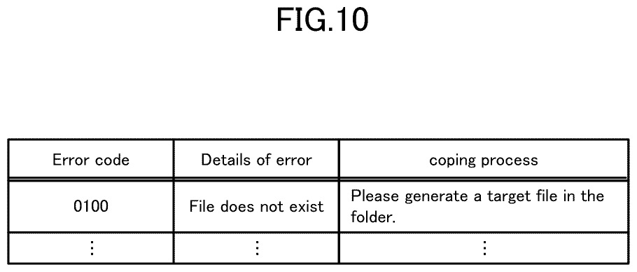

The storage 33 is mainly implemented by the auxiliary storage 43 of the terminal device 30. The storage 33 stores various logs received by the receiver 32. The storage 33 also stores error codes that can be contained in the communication data, details of the error codes, and processes of coping with the errors indicated by the error codes in association with each other, as illustrated in FIG. 10. The storage 33 corresponds to an example of storage means for storing, in association with each other, error codes and details of errors indicated by the error codes.

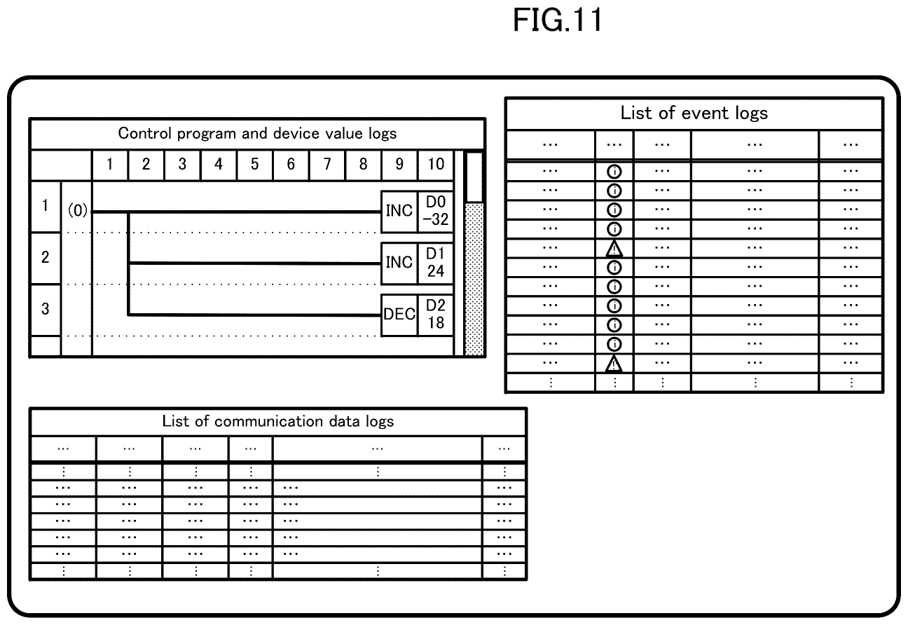

The display 34 is mainly implemented by cooperation of the processor 41 and the outputter 45 of the terminal device 30. The display 34 displays lists of the logs stored in the storage 33, in accordance with a manipulation of the user U1. FIG. 11 illustrates an exemplary screen displayed on the display 34. This screen shows the list of event logs illustrated in FIG. 5 and the list of communication data logs illustrated in FIG. 9. The screen also shows, along with the diagram of the control program P2, the device values used in the control program P2 and recorded at a certain timing. FIG. 11 illustrates an example including the device value −32 at the address “D0” and the device value 24 at the address “D1”. Alternatively, the display 34 may display the first one of the recorded device values as an initial value on the screen.

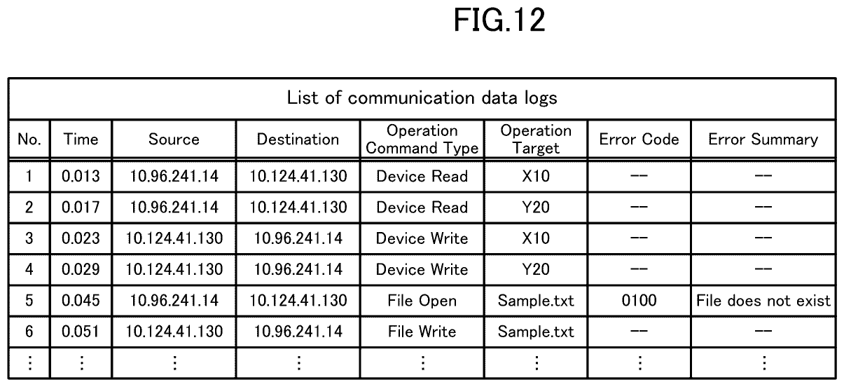

The display 34 may also display a table illustrated in FIG. 12 as the list of communication data logs, instead of the table illustrated in FIG. 9. This table is a list of row data that associates with each other No. indicating the number of the piece of row data, Time indicating the time of collection of the communication data provided with this number, Source and Destination indicating the source and destination of the communication data, Operation Command Type indicating the type of the operation command contained in the communication data, Operation Target indicating the target of the operation command, Error Code indicating the error code contained in the communication data, and Error Summary indicating the details of the error.

The table illustrated in FIG. 12 is generated by modifying the original logs of communication data illustrated in FIG. 9. In detail, the type of the operation command and the target of the operation command among the items illustrated in FIG. 12 are obtained by analyzing Info in the list illustrated in FIG. 9. The error code and the details of the error are obtained by referring to the information on errors illustrated in FIG. 10. The display 34 corresponds to an example of display means for displaying the logs of the device values, the logs of the predetermined events, and the logs of the communication data, the display means being configured to display, when the logs of the communication data contain any of the error codes, details of an error indicated by the error code.

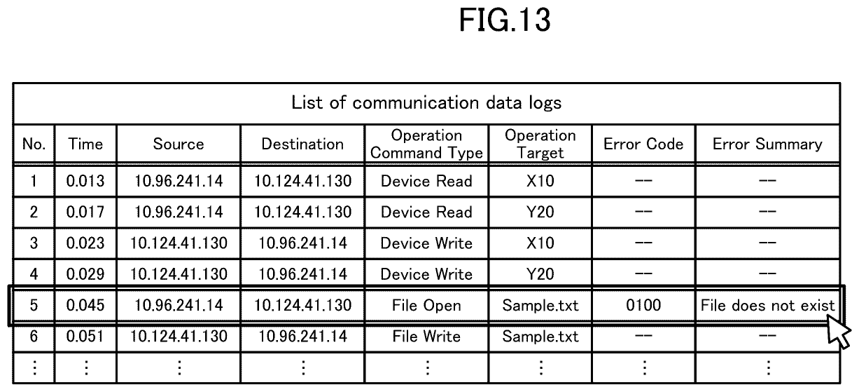

Referring back to FIG. 3, the acceptor 35 is mainly implemented by the inputter 44 of the terminal device 30. The retriever 36 is mainly implemented by the processor 41 of the terminal device 30. The acceptor 35 accepts selection of any of the logs in the list of communication data logs by the user U1, for example, as illustrated in FIG. 13. In FIG. 13, the selected log is emphasized with a frame. The selected log contains an error code “0100”. This error code is contained in response data when the file opening fails due to the absence of the target file in the PLC 10.

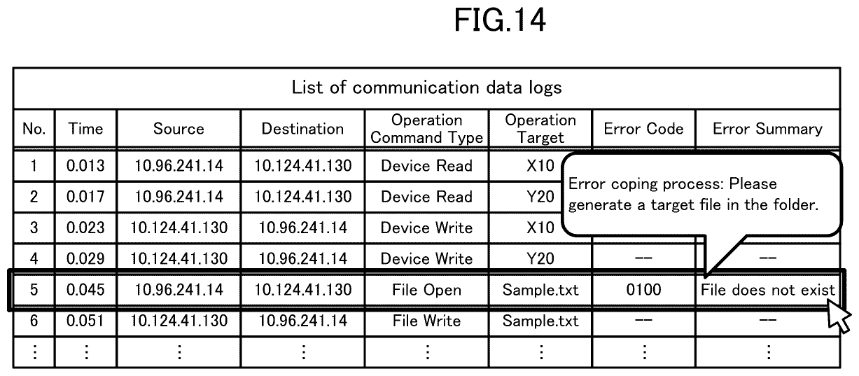

The retriever 36 then retrieves a process of coping with the error associated with the selected log from the storage 33. The display 34 then displays the retrieved coping process in a pop-up window, as illustrated in FIG. 14. FIG. 14 illustrates the error coping process associated with the error code “0100” as illustrated in FIG. 10.

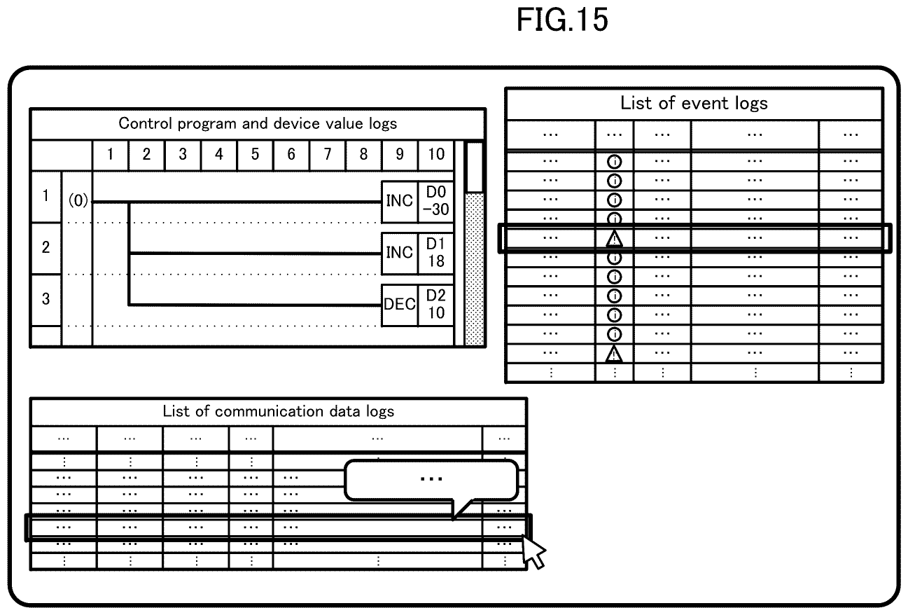

When any of the logs is selected from the list of communication data logs as indicated with the cursor in FIG. 15, the retriever 36 retrieves, from the storage 33, an event log and a device value log associated with this communication data log, on the basis of the time information. In detail, the retriever 36 identifies the time indicated by the time information provided to the selected communication data log, and retrieves an event log and a device value log provided with time information indicating the time identical to the identified time or the time having the smallest difference from the identified time. The display 34 then emphasizes the event log retrieved by the retriever 36, as illustrated in FIG. 15. The selected communication data log and the event log recorded simultaneously with the selected log are both emphasized, thereby highlighting their correspondence.

The display 34 replaces the device value log existing in the screen with the device value log retrieved by the retriever 36. FIG. 15 illustrates an example of the device value −30 at the address “D0”. The selected communication data log and the device value log recorded simultaneously with the selected log are both displayed on the screen, thereby highlighting their correspondence. The display 34 corresponds to an example of display means for identifying, based on the time information, a log of a device value associated with the selected log, and displaying, in association with each other, the selected first log, the second log retrieved by the retrieval means, and the identified log of the device value.

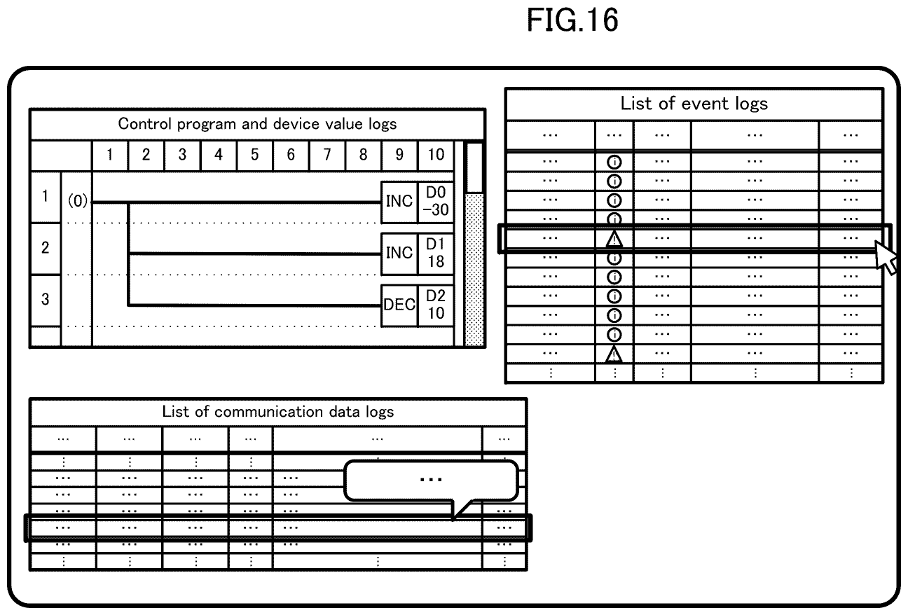

The acceptor 35 accepts selection of any of the logs from the list of event logs by the user U1, as indicated with the cursor in FIG. 16. The retriever 36 then retrieves, from the storage 33, a communication data log and a device value log associated with the selected event log, on the basis of the time information. The retrieved communication data log is emphasized, and the retrieved device value log appears with the name of the device value in the diagram of the control program P2.

That is, the acceptor 35 accepts selection of a log of either one of the communication data logs and the event logs, and the retriever 36 retrieves a log of the other one of the logs and a device value log associated with the selected log. The acceptor 35 corresponds to an example of acceptance means for accepting selection of any first log from a first log list containing first logs, the first logs being the logs of the predetermined events or the logs of the communication data. The retriever 36 corresponds to an example of retrieval means for retrieving, based on the time information, a log associated with the selected first log, from a second log list containing second logs, the second logs being the logs of the predetermined events or the logs of the communication data and being different from the first logs. The display 34 corresponds to an example of display means for displaying, in association with each other, the selected first log and the second log retrieved by the retrieval means.

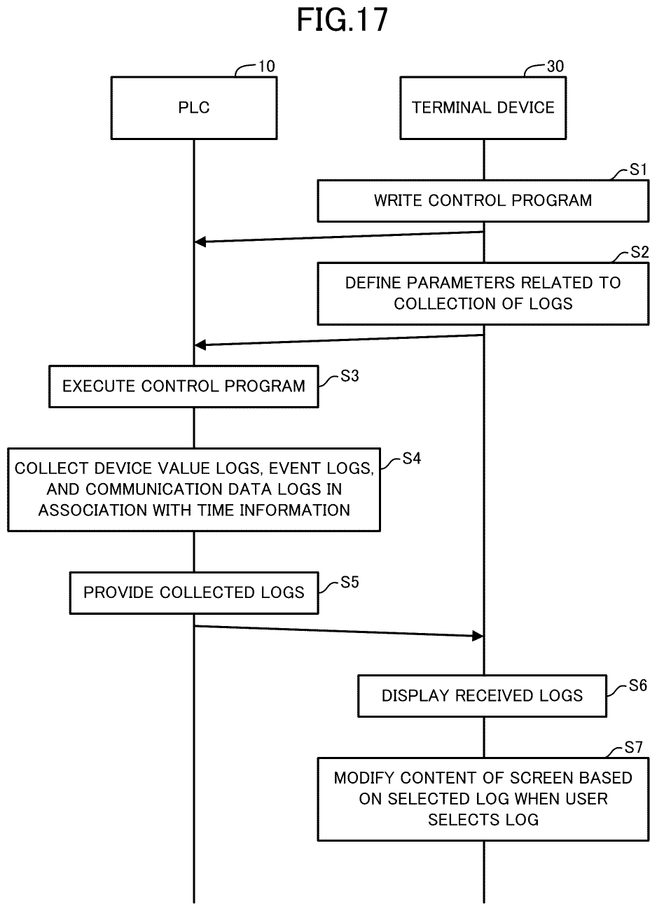

The following describes a process of providing information to the user U1 executed by the PLC 10 and the terminal device 30 having the above-described functions, with reference to FIG. 17. As illustrated in FIG. 17, the terminal device 30 writes the control program P2 generated by the user U1 into the PLC 10 (Step S1), and defines some parameters related to collection of logs in the PLC 10 (Step S2). The PLC 10 then controls the control-target machine 20 by executing the control program P2 (Step S3), and collects the device value logs, the event logs, and the communication data logs in association with the time information, during execution of the control program P2 (Step S4).

The PLC 10 then provides the collected logs to the terminal device 30 in response to a request from the terminal device 30 (Step S5). The terminal device 30 then displays lists of the received logs for the user U1, as illustrated in FIG. 11 (Step S6). When the user U1 selects any of the logs as illustrated in FIGS. 13, 15, or 16, the terminal device 30 modifies the content of the screen as illustrated in FIGS. 14, 15, or 16, thereby clarifying the correspondence among the three types of logs (Step S7). The user U1 can thus readily recognize the correspondence among the three types of logs, and efficiently analyze the process to identify the cause of the error. The process of providing information illustrated in FIG. 17 corresponds to an example of a method of providing information.

As described above, the PLC 10 provides three types of logs in association with the time information. This technique can reduce the time required for a maintenance operation based on the logs recorded in the PLC 10.

The communication log collector 15 also collects communication data containing an operation command directed to device values or files related to the control program P2. After any change in the device values or files related to the control program P2, the communication log collector 15 switches its collection targets to communication data containing an operation command directed to the changed device values or files. This configuration can narrow down the collection targets to necessary communication data, without requiring the user U1 to pay attention to a change in collection parameters.

Alternatively, the communication log collector 15 may collect communication data transmitted in accordance with a protocol related to the control program P2. After any change in the protocol related to the control program P2, the communication log collector 15 switches its collection targets to communication data transmitted in accordance with the changed protocol. This configuration can narrow down the collection targets to necessary communication data, without requiring the user U1 to pay attention to a change in collection parameters.

The display 34 displays details of an error on the basis of the error code contained in the communication data, along with a process of coping with the error. This configuration enables the user U1 to readily find out potential abnormalities related to communication errors, which are not apparent from the observation of the device value logs and the event logs. The configuration also allows the user U1 to correct the error in accordance with the coping process, without a task of analyzing the error by the user U1.

### Embodiment 2

The following describes Embodiment 2, focusing on the differences from Embodiment 1 described above. The components identical or corresponding to those in Embodiment 1 are provided with the same reference symbol. In Embodiment 1, the retriever 36 retrieves a log associated with the time identical to or having the smallest difference from the time of the selected log. The selected log and the log to be retrieved, however, may have time information indicating mutually different times, due to a processing time of the processor 41 of the PLC 10 and a communication delay, for example. The following describes an example in which the retriever 36 retrieves a log associated with time information indicating time different from that of the selected log.

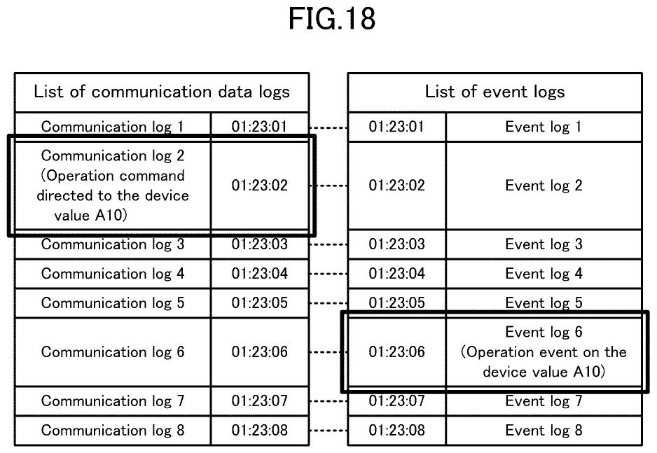

FIG. 18 illustrates the list of communication data logs and the list of event logs, such that each pair of the logs associated with the identical time information are connected with each other by a dashed line. In Embodiment 1 described above, when a communication log 2 is selected among communication logs 1 to 8, the retriever 36 retrieves an event log 2 associated with the identical time information from event logs 1 to 8, as is apparent from FIG. 18.

In contrast, the retriever 36 in this embodiment retrieves a log, on the basis of the details of communication logs and event logs. For example, as illustrated in FIG. 18, when the communication log 2 is communication data containing an operation command directed to the device value A10, the retriever 36 retrieves the event log 6 of an operation event on this device value A10.

That is, the retriever 36 retrieves a log characterized by both of the identical type of operation on the memory 11 and the identical address of the device value or file subject to the operation. Examples of the type of operation include operations of reading and writing of the device value, and operations of reading and writing of the file. The retriever 36 thus finds out the correspondence between the communication log containing a reading operation on the device value A10 and the event log containing a reading operation on the device value A10. In contrast, the retriever 36 finds out no correspondence between the communication log containing a reading operation on the device value A10 and the event log containing a writing operation on the device value A10. The retriever 36 also finds out no correspondence between the communication log containing a reading operation on the device value A10 and the event log containing a reading operation on the device value A20.

In general, such a possible difference between the time of a communication data log and the time of an event log associated with this communication data log is expected to be relatively short. The retriever 36 thus identifies any of the logs associated with time information indicating time differing from the time of the log selected by the user U1 by a predetermined threshold or shorter, on the basis of the details of the logs.

The retriever 36 corresponds to an example of retrieval means for retrieving a second log associated with the time information indicating time having a smaller difference from the time indicated by the time information associated with the selected first log than a threshold difference, the second log having details related to details of the first log.

As described above, the retriever 36 searches for a log having related details, while allowing a certain degree of time difference. The retriever 36 thus retrieves an appropriate log corresponding to the log selected by the user U1 to be displayed. This configuration improves the efficiency of the maintenance operation of the user U1.

The above-described embodiments are not to be construed as limiting the scope of the present disclosure.

For example, although the retriever 36 retrieves any one log corresponding to the log selected by the user U1 in the above embodiments, this configuration is a mere example. The retriever 36 may retrieve multiple logs.

Although the accumulated logs are stored in both of the log storage 17 of the PLC 10 and the storage 33 of the terminal device 30 in the above embodiments, the logs may be stored in either one of the storages. In a modification including no log storage 17 of the PLC 10, the logs generated in the PLC 10 are sequentially transmitted from the provider 19 to the terminal device 30, and accumulated in the storage 33. In another modification including no storage 33 of the terminal device 30, the terminal device 30 is provided with the logs from the provider 19, by retrieving a log from the log storage 17 of the PLC 10 as required.

The functions of the PLC 10 and the terminal device 30 according to the above-described embodiments may be performed by dedicated hardware or an ordinary computer system.

For example, the program P1 may be stored in non-transitory computer-readable recording media, such as flexible disks, compact disk read-only memories (CD-ROMs), digital versatile disks (DVDs), and magneto-optical disks (MOs), and distributed. The program P1 may then be installed in a computer, so as to configure the device for executing the above-described processes.

Alternatively, the program P1 may be stored in a disk drive included in a server device on a communication network, such as the Internet, and may be downloaded into a computer by being superimposed on a carrier wave, for example.

Alternatively, the program P1 may be activated while being transferred through a network, such as the Internet, to execute the above-described processes.

A server device may execute all or part of the program P1, and a computer may execute the program P1 while transmitting and receiving information on the executed processes to and from the server device via a communication network, to execute the above-described processes.

In the case where the above-described functions are shared by an operating system (OS) or achieved by cooperation of the OS and applications, only the components other than the OS may be stored into a non-transitory medium and distributed, or downloaded into a computer.

The functions of the PLC 10 and the terminal device 30 may also be performed by means other than software. Part or all of the functions may be performed by dedicated hardware or circuits.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### Industrial Applicability

The present disclosure is suitable for maintenance operations in FA systems.

### REFERENCE SIGNS LIST

10 PLC
11, 21 Memory
12 Program executor
13 Value log collector
14 Event log collector
15 Communication log collector
16 Communicator
17 Log storage
18 Time information acquirer
19 Provider
20 Control-target machine
30 Terminal device
31 Setter
32 Receiver
33 Storage
34 Display
35 Acceptor
36 Retriever
40 FA device
41 Processor
42 Main storage
43 Auxiliary storage
44 Inputter
45 Outputter
46 Communicator
47 Internal bus
51 to 53 Log
100 Information service system
111,211 Device value
P1 Program
P2 Control program
U1 User

1. A programmable controller for controlling a machine, the programmable controller comprising:
processing circuitry to execute a control program for controlling the machine;
a memory to be shared with the machine; and
communicator to communicate with at least one of the machine or a device different from the machine via a network, wherein
the processing circuitry
collects, during execution of the control program, logs of values stored in the memory,
collects logs of predetermined events occurring inside the programmable controller, the predetermined events including operation events on the values stored in the memory,
collects logs of communication data transmitted or received by the communicator,
acquires time information indicating time and
provides the logs of the values, the logs of the predetermined events, and the logs of the communication data in association with the time information indicating times of collection of the individual logs.

2. The programmable controller according to claim 1, wherein the processing circuitry collects the logs of the communication data containing an operation command directed to the values used in the control program or used as parameters of the control program or directed to files stored in a storage separate from the memory.

3. The programmable controller according to claim 1, wherein the processing circuitry collects the logs of the communication data transmitted in accordance with a protocol used in the control program or a protocol of communications related to parameters of the control program.

4. A terminal device to receive, in association with the time information, each of the logs of the values, the logs of the predetermined events, and the logs of the communication data from the programmable controller according to claim 1, the terminal device comprising:
storage to store, in association with each other, error codes and details of errors indicated by the error codes; and
display to display the logs of the values, the logs of the predetermined events, and the logs of the communication data, the display being configured to display, when the logs of the communication data contain any of the error codes, details of an error indicated by the error code.

5. The terminal device according to claim 4, further comprising:
input device to accept selection of any first log from a first log list containing first logs, the first logs being the logs of the predetermined events or the logs of the communication data; and
another processing circuitry to retrieve based on the time information, a log associated with the selected first log, from a second log list containing second logs, the second logs being the logs of the predetermined events or the logs of the communication data and being different from the first logs, wherein
the display displays, in association with each other, the selected first log and the second log another processing circuitry.

6. The terminal device according to claim 5, wherein the another processing circuitry retrieves a second log associated with the time information indicating time having a smaller difference from the time indicated by the time information associated with the selected first log than a threshold difference, the second log having details related to details of the first log.

7. The terminal device according to claim 5, wherein the display
identifies, based on the time information, one of the logs of the values associated with the selected first log, and
displays, in association with each other, the selected first log, the second log retrieved by the another processing circuitry, and the identified one of the logs of the values.

8. A method of providing information executed by a programmable controller for controlling a machine, the method comprising:
executing, by a program executer, a control program for controlling the machine;
collecting, by a value log collector, logs of values during execution of the control program, the values being stored in a memory to be shared between the programmable controller and the machine;
collecting, by an event log collector, logs of predetermined events occurring inside the programmable controller, the predetermined events including operation events on the values stored in the memory;
communicating, by a communicator, with at least one of the machine or a device different from the machine via a network;
collecting, by a communication log collector, logs of communication data transmitted or received by the communicator;
acquiring, by a time information acquirer, time information indicating time; and
providing, by a provider, the logs of the values, the logs of the predetermined events, and the logs of the communication data, in association with the time information indicating times of collection of the individual logs.

9. A non-transitory recording medium storing a program for a computer connected to a programmable controller, the program causing the computer to perform operations comprising:
receiving, in association with time information indicating times of collection of individual logs by the programmable controller, the logs from the programmable controller, the logs including logs of values stored in a memory to be shared between the programmable controller and a machine to be controlled, logs of events occurring inside the programmable controller, and logs of communication data transmitted or received by the programmable controller via a network;
storing, in association with each other, error codes and details of errors indicated by the error codes; and
displaying, by a display, the logs of the values, the logs of the events, and the logs of the communication data, the display being configured to display, when the logs of the communication data contain any of the error codes, details of an error indicated by the error code.
